(19) United States
(12) Patent Application Publication
(10) Pub. No.: US 2022/0222527 A1
(43) Pub. Date: Jul. 14, 2022

(54) METHOD FOR PREDICTING HARDWARE FAULT USING MACHINE LEARNING

(71) Applicant: UNIVERSITY OF LOUISIANA AT LAFAYETTE, Lafayette, LA (US)

(72) Inventors: Kasem KHALIL, Lafayette, LA (US); Omar Eldash, Lafayette, LA (US); Ashok Kumar, Lafayette, LA (US); Magdy Bayoumi, Lafayette, LA (US)

(73) Assignee: UNIVERSITY OF LOUISIANA AT LAFAYETTE, Lafayette, LA (US)

(21) Appl. No.: 17/575,729

(22) Filed: Jan. 14, 2022

Related U.S. Application Data
(60) Provisional application No. 63/137,219, filed on Jan. 14, 2021.

(51) Int. Cl. G06N 3/08; G06K 9/00; G06N 3/04

(52) U.S. Cl. CPC G06N 3/08; G06N 3/04; G06K 9/00536; G06K 9/00523

(57) ABSTRACT

Hardware failures are undesired, but a common problem in circuits. Such failures are inherently due to the aging of circuitry or variation in circumstances. In critical systems, customers demand that the system never fail. Several self-healing and fault tolerance techniques have been proposed in the literature for recovering a circuitry from a fault. Such techniques are helpful when a fault has already occurred, but they are typically uninformed about the possibility of an impending failure (i.e., fault prediction), which can be used as a pre-stage to fault tolerance and self-healing. Presented herein is a method for early prediction of circuit faults. Using Fast Fourier Transformation (FFT), Principal Component Analysis (PCA), and Convolutional Neural Network (CNN), circuit faults can be predicted at a transistor level.

### CROSS REFERENCE TO RELATED APPLICATIONS

This application claims priority to U.S. Provisional Application No. 63/137,219 titled “Hardware Fault Prediction Based on Machine Learning” filed on Jan. 14, 2021.

### STATEMENT REGARDING FEDERALLY SPONSORED RESEARCH OR DEVELOPMENT

Not applicable.

### REFERENCE TO A “SEQUENCE LISTING”, A TABLE, OR COMPUTER PROGRAM

Not applicable.

### FIELD OF THE INVENTION

The invention relates generally to the field of reducing faults in circuitry, specifically in relation to using neural networks to predict and respond to anticipated faults in circuitry.

### BACKGROUND OF THE INVENTION

Progressive scaling of a device in a hardware system and Very Large Scale Integrated (VLSI) has enabled the creation of more complex circuits and systems. However, decreasing device size increases vulnerability to faults due to design defects, high energy particles, and aging. Consequently, the reliability of hardware is reduced, and such reduced reliability causes significant concern for devices used for critical needs such as healthcare and security.

The traditional way to handle fault tolerance (or self-healing) in the art has been to implement redundancy or replication. Advanced VLSI introduces more complex processors and systems, implemented on advanced hardware architecture. The hardware system performance may decrease or break due to hardware failures in some components. Failures occur when running some real-life tasks due to the aging of the hardware system or the surrounding environment changes. At the circuit level, a scaling of transistor technology also causes process variation, which causes degraded performance yield. Process variations have a significant impact on digital circuits. They have a significant impact on mixed-signal and analog circuits, because of the design sensitivity to device mismatch and integration of sub-blocks that can vary in parameters such as noise, characteristics, and operating frequency.

Fault prediction techniques can significantly help the self-healing of a hardware system. A self-healing approach uses fault detection to know which part of the circuit or system has a fault to compensate (compensation is typically done through redundancy or replication). Self-healing is a part of intelligent hardware system research which aims to make the hardware system smart. The intelligent hardware system is an important framework that is used for hardware optimization based on the changes in the surroundings, running operations, and competing goals.

In biomedical devices, an Electrocardiogram (ECG) is used to record the electrical activity of the heart. It presents the heart rate and rhythm information. It shows a diagnosis in case if there is heart enlargement due to high blood pressure, which is called hypertension or myocardial infarction, and is evidence of previous heart attack. In the biomedical hardware component, a comparator is used to compare the input signal with a threshold reference voltage. The comparator is also used in Analog to Digital Converters (ADCs), which is used for ECG data recording. An amplifier is also used in biomedical instrumentation systems. Input signals are sensitive to noise, and its voltage value is low. These signals are amplified, by the amplifier, for signal processing and ADCs. The main and common component of the comparator, amplifier, and all electronic circuits is a transistor. Therefore, transistor faults/failures are vital to consider in the design as well as fault predictions.

Transistor faults are a result of aging or circumstance changes such as voltage, current, noise, delay, and temperature. Therefore, the transistor diagnosis must study these parameters for detecting or predicting faults/failures. There are several techniques to detect an existing fault. A self-healing or fault tolerance technique is then applied to fix the fault. The drawback of fault detection is that some tasks or data will be lost due to the current fault (since the fault is fixed after it has already occurred), and it affects the system performance. The goal to solve this problem is a fault prediction that provides early transistor diagnosis. Thus, the machine learning role comes to provide an early prediction. Machine learning has different structures, such as a Recurrent Neural Networks (RNN) and Convolutional Neural Network (CNN). The machine learning method depends on faults' parameters for learning. The benefit of early fault prediction is that it can help self-healing/fault tolerance methods to fix the fault before it occurs, thus protecting the system performance. The data from fault prediction can be used by self-healing method to recover a fault. As the self-healing method gets the information of an imminent fault time and location, it can recover it without incurring a down-time for the system.

A fault is an abnormal physical condition in a hardware system that causes an error. An error is a demonstration of a fault in the hardware system. The output deviates from the expected value because the logical state of a component differs from the intended state. Furthermore, failure is the inability of the system to perform its functionality or behavior. A failure might happen due to chain error propagation to the system level. However, the fault in the hardware system is not a significant result in an error or failures as it might become inactive. Failure has occurred as a type of communication failures because of broken wire, loosening connectors, circuit board level shorts and opens, failing communication transceivers, communication timing issues, and electromagnetic interference. Transistor aging has become as troublesome phenomena in complex processors. The aging results in performance degradation and failure. The main aging mechanisms are Electromigration (EM), Stress Migration (SM), Negative Bias Temperature Instability (NBTI), Time-Dependent Dielectric Breakdown (TDDB), and Hot Carrier Injection (HCI).

EM results due to the excessive stress of current density. This phenomenon lead to a sudden delay increase, short, or open faults. The EM issue is located in the interconnect, and it can be defined as the physical displacement of the ions of metal in the interconnection wires. This kind of displacement is resulted due to a large flow of electronics (which is called a large current density mechanism) that interacts with the metal ions. Voids and hillocks are resulted due to this movement, and this phenomenon causes short circuits or open connections. As the EM is accelerated close to the metal grain boundaries, contact holes and vias are susceptible to this impact. The EM expression is derived in terms of Mean Time to Failure (MTTF) as:

$${MTTF}_{EM} \text{\textasciitilde} {AJ}^{- n} {exp}^{\frac{{E}_{aEM}}{KT}}$$

where A is the cross-section area of the wire, J is the current density in the wire, Ea_{EM} is EM's material-dependent activation energy constant (0.9 for the copper interconnects), n is interconnect metal constant (1.1 for the copper interconnects), K is the Boltzmann constant, and T is the absolute temperature in Kelvin. Therefore, with a larger A and a smaller J, it results in a longer lifetime MTTF.

The SM occurs due to excessive structural stress. This phenomenon is similar to EM where it leads to a sudden delay increase, short, or open faults. In this mechanism, the metal atoms migrate in the interconnects because of mechanical stress which is similar to electromigration. The stress migration is resulted by thermo-mechanical stresses that are produced by different rates of thermal expansion of different materials. The calculation of EM depends on MTTF due to stress migration, and it can be written by:

$${MTTF}_{SM} \text{\textasciitilde} {\vert {T}_{0} - T \vert}^{- m} {exp}^{\frac{{E}_{aSE}}{KT}}$$

where TO is the metal stress-free temperature which is the deposition temperature of the metal, Ea_{SM} is the material-dependent activation energy constant (0.9 for the copper interconnects), m is material constant (2.5 for the copper interconnects).

NBTI affects a PMOS transistor in terms of threshold voltage degradation due to a stressed transistor with negatively biased gate voltage. NBTI can be defined as a threshold voltage shift due to a negative bias is applied to the gate of MOS at high temperature. The threshold voltage shift Vth depends on temperature, stress time, and voltage. The BTI voltage shift ΔVth can be written as follows:

$$Δ {V}_{t h} = A {exp}^{( β {V}_{G S} )} {exp}^{( - \frac{{E}_{a}}{K T} )} {α}^{n} {t}^{n}$$

where A, β, and n are constants, V_{GS} is the gate voltage, α is the duty cycle which is the ratio of the stress time to total time, and t is operating time. Eₐ is the BTI activation energy constant.

TDDB refers to insulating film breakdown due to continuous stresses to a gate oxide-film causes. It causes a sudden delay increase (slow delay degradation up to a certain point) or a failure. There are different Breakdown (BD) modes: Hard-BD (HBD) and Soft-BD (SBD). The HBD is the most harmful mode, and it causes a complete loss of the dielectric oxide properties with gate currents in the rage of mA. The SBD is defined as a partial loss of the oxide dielectric properties, and it causes an increase in the noise and magnitude of the gate current. The time to breakdown (tDB) is expressed as probability distribution:

$$F ( {t}_{BD} ) = 1 - {exp}^{- {( \frac{{t}_{DB}}{{t}_{63}} )}^{β}}$$

where t₆₃ is the time to breakdown at 63%, and it proportional to the size of the transistor and inversely proportional to V_{GS}. β is called a process-dependent constant.

HCI affects a NMOS transistor by increasing the threshold voltage under the stress of source-drain voltage. It causes gradual delay degradation the same as NBTI. The hot carriers are defined as particles that have high kinetic energy which is accelerated by a high electric field. The energetic electrons may be injected into the forbidden regions of the transistor (gate oxide layer). These electrons can get trapped or cause an up-normal interface. This kind of defect leads to an increased threshold voltage of Vₜₕ. Hot carrier effect is modeled using a power-law dependency on the stress time. The damage is proportional to increasing gate to source voltage (V_{GS}), drain to source voltage (V_{DS}).

$$Δ {V}_{th} \text{\textasciitilde} \frac{1}{\sqrt{L}} {exp}^{( {α}_{1} {V}_{GS} )} {exp}^{( {α}_{2} {V}_{DS} )} {T}^{{n}_{HC}}$$

where L is the transistor length, T is temperature, n_{HC} is constant (n_{HC}=0.5), α₁ and α₂ are technology-dependent constant of voltage scaling.

The classification of faults is divided into three categories: permanent, transient, and intermittent fault. The permanent fault is irretrievable physical damage in the system, and it is a continuous fault and stable with time. The permanent fault results from different sources such as; stuck-at zero or stuck-at one which fixes the logic values, short circuit due to a connection between two lines. Open line is another fault that results from splitting a line into parts. Delay fault is due to the propagation delay in the hardware system. Furthermore, bridge source is due to two wires in a network that are connected accidentally, and wire then performs as a connection.

The transient fault is a fault that comes from external disturbance, and it may stay for a short period. According to transient time faults, there are three types: bit-flip, pulse, and delay. Bit-flip occurs when a value of bit changes to the opposite value, for example, switching value from ‘1’ to ‘0’ or vice versa. Pulse comes from the transition of a pulse, which is called single event transition. Delay comes from the mismatch in hardware, which makes propagation delay.

The intermittent fault is the third type, which results from unstable or marginal device operation, and it is difficult to detect them compared to the permanent one. This type of fault is a kind of transient fault that repeats with some frequencies.

The foregoing is a non-limiting summary of the invention, which is defined by the attached claims.

### DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing.

FIG. 1 provides a block diagram of the disclosed method.

FIG. 2(a) provides a schematic diagram of the fault model for an open-circuit fault.

FIG. 2(b) provides a schematic diagram of the fault model for a short-circuit fault.

FIG. 3 provides a line drawing representation of a convolutional neural network architecture.

FIG. 4 provides a rendering of a fully connected layer architecture.

FIG. 5 provides a training flow chart of the disclosed method.

FIG. 6 provides a flow diagram model of the training and testing of data using CNN.

FIG. 7 provides a schematic diagram of a comparator.

FIG. 8 provides a schematic diagram of an amplifier.

FIG. 9 provides the comparator input signal.

FIG. 10 provides the comparator output signal of the open-circuit fault state.

FIG. 11 provides the comparator output signal of the short-circuit fault state.

FIG. 12 provides the amplifier input signal of the normal state.

FIG. 13 provides the amplifier output signal of the normal state.

FIG. 14 provides the amplifier output signal of the open-fault state.

FIG. 15 provides the amplifier output signal of the short-circuit fault state.

FIG. 16 provides a chart of the harmonics voltage amplitude after FFT without fault.

FIG. 17 provides a chart of the harmonics voltage amplitude after FFT of open-circuit fault.

FIG. 18 provides a chart of the harmonics voltage amplitude after FFT of short-circuit fault.

FIG. 19 provides a chart of the harmonics current amplitude after FFT without fault.

FIG. 20 provides a chart of the harmonics current amplitude after FFT of open-circuit fault.

FIG. 21 provides a chart of the harmonics current amplitude after FFT of short-circuit fault.

FIG. 22 provides a line graph of the simulation result of the principal component.

FIG. 23 provides a line graph of the mean square error of the learning method.

FIG. 24 provides a table of the evaluation parameter results.

FIG. 25 provides a table of the comparison between the disclosed method and techniques currently known in the art.

FIG. 26 provides a table of the learning performance results.

FIG. 27 provides a comparison of resources utilization on hardware implementation between the disclosed method and other methods known in the art.

FIG. 28 provides a chart of the hardware utilization of FFT.

FIG. 29 provides a chart of the hardware utilization of PCA.

### SUMMARY OF THE INVENTION

Disclosed herein is an approach to transistor fault prediction. This technique provides a high-accuracy machine learning method for predicting hardware faults. Early fault prediction helps to diagnose the fault. Therefore, the fault can be fixed early to avoid any missed data or operations.

The hardware fault prediction model first provides fault prediction in the transistor level, and it is based on Fast Fourier Transformation (FFT), Principal Component Analysis (PCA), and CNN. Next, the disclosed prediction method is tested herein using two different circuits: comparator and amplifier that are used for ADC applications. The testing reflects that the scalability of the method for different circuits with the same performance. The disclosed method provides a prediction with an accuracy of 98.93% which is higher than the traditional methods.

### DETAILED DESCRIPTION OF THE INVENTION

The following description sets forth exemplary methods, parameters, and the like. It should be recognized, however, that such description is not intended as a limitation on the scope of the present disclosure but is instead provided as a description of exemplary embodiments.

In the following description of the disclosure and embodiments, reference is made to the accompanying drawings in which are shown, by way of illustration, specific embodiments that can be practiced. It is to be understood that other embodiments and examples can be practiced, and changes can be made, without departing from the scope of the disclosure.

In addition, it is also to be understood that the singular forms “a,” “an,” and “the” used in the following description are intended to include the plural forms as well unless the context clearly indicates otherwise. It is also to be understood that the term “and/or” as used herein refers to and encompasses any and all possible combinations of one or more of the associated listed items. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulations of physical quantities as modules or code devices without loss of generality.

However, all of these and similar terms are to be associated with the appropriate physical quantities and are merely convenient labels applied to these quantities. Unless specifically stated otherwise as apparent from the following discussion, it is appreciated that, throughout the description, discussions utilizing terms such as “processing,” “computing,” “calculating,” “determining,” “displaying,” or the like refer to the action and processes of a computer system, or similar electronic computing device, that manipulates and transforms data represented as physical (electronic) quantities within the computer system memories or registers or other such information storage, transmission, or display devices.

Certain aspects of the present invention include process steps and instructions described herein in the form of an algorithm. It should be noted that the process steps and instructions of the present invention could be embodied in software, firmware, or hardware, and, when embodied in software, they could be downloaded to reside on, and be operated from, different platforms used by a variety of operating systems.

The present invention also relates to a device for performing the operations herein. This device may be specially constructed for the required purposes or it may comprise a general-purpose computer selectively activated or reconfigured by a computer program stored in the computer. Such a computer program may be stored in a non-transitory, computer-readable storage medium such as, but not limited to, any type of disk, including floppy disks, optical disks, CD-ROMs, magnetic-optical disks, read-only memories (ROMs), random access memories (RAMs), EPROMs, EEPROMs, magnetic or optical cards, application-specific integrated circuits (ASICs), or any type of media suitable for storing electronic instructions and each coupled to a computer system bus. Furthermore, the computers referred to in the specification may include a single processor or may be architectures employing multiple processor designs for increased computing capability.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention, as described herein.

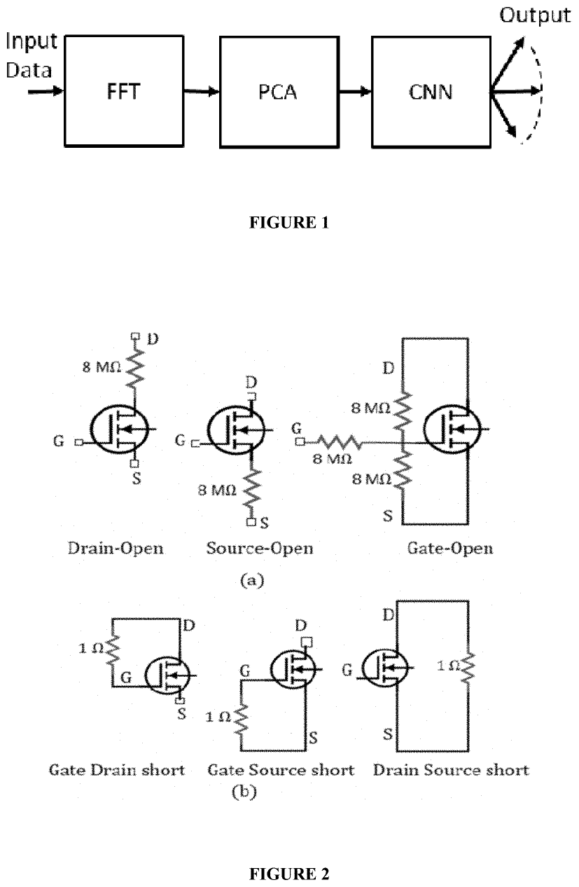

Hardware faults cause performance degradation in a hardware system. Disclosed herein is a novel approach for fault prediction in terms of aging, short-circuit, and open-circuit fault. The disclosed method depends on FFT, PCA, and CNN, as shown in FIG. 1. The FFT is used to demonstrate a signal in the frequency domain, which gives a more suitable indication of faults. The fault impact on a signal is dominated by some major frequency components, and the dominant frequencies are significant for monitoring. The spectrum for low to high frequencies indicates an earlier warning of faults resulted from frequency components with smaller amplitudes. Different changes, also, in the frequency components and their bands are associated with various faults.

The next stage is based on PCA which is used to get the most important parameters where it removes unimportant data. The CNN gets the PCA's output as an input to learn from it the kind of faults and provides the fault classification at the final output result. The contribution of the disclosed method can be explained as follows. Traditionally, fault detection/prediction can be provided using an Artificial Neural Network (ANN) or Support Vector Machine (SVM). The fault signals do not contain a lot of information to get an accurate result using ANN or SVM. Therefore, the first point is to extend the fault signal for getting sufficient data in learning.

From this point, the idea of using FFT to the fault signals comes to extend the data. The data in the frequency domain provides a signature and characteristic of fault. After FFT, the data has some unimportant information as before FFT. Therefore, the PCA processing is used to remove this unimportant information to reduce the training time of CNN. The data after all these processes are still large and sufficient (the data has large sufficient features) for learning a network using CNN. The final data are complex; thus, CNN (CNN is used for complex data) is used for feature extraction and classification. The disclosed method provides more accurate data to predict faults compared with the traditional methods such as ANN and SVM. This is due to that ANN and SVM are not a good choice for large sample classification while the disclosed method can deal with large data using CNN. The description of each stage is discussed now.

Dataset and Fault Model. The method predicts a fault of a comparator and amplifier. These circuits are implemented on HSPICE using 45 nm technology. The implementation is sim-ulated to emulate aging, short-circuit, and open-circuit faults by modifying the diagnosis fault parameters. We extracted the data to build our dataset (voltage, current, noise, delay, temperature, EM, SM, NBTI, TDDB, HCI, input measurement errors, etc.) for the transistor level design, and this dataset is used in the disclosed approach. On the one hand, the transistor open-circuit fault can be one of these forms: drain open, source-open, and gate-open. On the other hand, the transistor short-circuit has different shapes: gate-drain-short, drain-source-short, and gate-source-short. The model of the transistor short and open circuit is based on low and high resistance, respectively.

For short-circuit fault, low resistance of 1Ω is considered while high resistance of 8 MΩ is considered to be open-circuit. The short-circuit and open-circuit faults are shown in FIG. 2. Using the experimental analysis, we changed the resistance for short-circuit until the voltage becomes very small and the voltage drop on this resistance has a very small variation when it is lower or equal to 1Ω. Therefore, the short-circuit resistance is chosen.

For the open-circuit situation, a high resistance is used to present it. We changed the resistance value, and it is found that the voltage drop is very high when the resistance is 8 MΩ. Also, the voltage variation is very small after increasing the resistance to more than 8 MΩ. According to these results, the low and high resistance are selected. The aging faults may cause delay, noise, threshold voltage variation, or open-circuit, or short-circuit fault. Each transistor in comparator and amplifier circuits may get any one of these faults. The comparator and amplifier implementation are analyzed using Monte-Carlo analysis to present the effect of the transistor threshold-voltage variation to the circuit behavior. This simulation is done 100 times with the 6% variation in the threshold voltage. The final data has 14,683 samples, and it includes 150 samples for the nonfaulty state.

Feature Extraction and Classification. The fault feature selection and extraction are used to get a presentation of the fault and classification status. The feature selection and extraction, in the disclosed approach, run through FFT, PCA, and CNN. FFT is used to get the frequency transformation of the input data. The PCA is used to reduce the data dimension by converting correlated data to uncorrelated data. This reduction will be helpful to CNN where the computation will be less. The CNN stage finalizes the feature extraction to be applied to the classification stage. Details of each stage will be discussed in the following subsections.

Fast Fourier Transform: Each hardware fault represents itself by a unique frequency signature. Therefore, FFT is used to represent faults in a frequency domain to be easier for identifying a fault. Furthermore, the FFT is used to do data compression and feature extraction by preprocessing on the original signals. The FFT is a version of the Discrete Fourier Transform (DFT), but the FFT is faster. The FFT utilizes some advanced methods to do the same thing as the DFT but in much less time. For instance, a DFT computation of N points in a fundamental way, using the definition, takes O(N²) arithmetic operations, while the FFT computation of the same result is in only O (N log N) operations.

Therefore, the advantages of using FFT can be described as follows. It provides the main features of a fault characteristic signals, it is easier to distinguish the faults by using the spectrum where each fault has a unique frequency signature, and FFT computation of N points is only O(N log N) operations. A window function is used to get finite sequences for processing. The FFT is used for fault prediction at the system level in an embryonic hardware system in which faulty cells are repaired. Here, the FFT processes output signals and the first b frequencies are used for the feature data for the next step to PCA, where b<<the number of samples which is obtained by iteration. The PCA is used to improve the diagnostic accuracy and computational efficiency of hardware faults.

Assume x_{i,n} is a discrete output signal (e.g., voltage, current, temperature, . . . ) with I=1, 2, 3, . . . , m and n=0, 1, 2, 3, . . . , b−1 where b is the retained harmonics size and m is the training samples size. The FFT is derived by:

$$X ( k ) = {\sum }_{n = 0}^{N - 1} x ( n ) {W}_{N}^{kn} , k = 0 , 1 , … , N - 1$$

$${W}_{N} = {e}^{\frac{- i 2 π}{N}}$$

$$X ( k ) = {\sum }_{n even} x ( n ) {W}_{N}^{kn} + {\sum }_{n odd} x ( n ) {W}_{N}^{kn}$$

$$X ( k ) = {\sum }_{m = 0}^{\frac{N}{2} - 1} x ( 2 m ) {W}_{N}^{2 km} + {\sum }_{m = 0}^{\frac{N}{2} - 1} x ( 2 m ) {W}_{N}^{2 km}$$

With W_{N}²=w_{N/s} substitution, the equation can be expressed as

$$= {\sum }_{m = 0}^{\frac{N}{2} - 1} {h}_{1} ( m ) {W}_{N / 2}^{km} + {\sum }_{m = 0}^{\frac{N}{2} - 1} {h}_{2} ( m ) {W}_{N / 2}^{km}$$

$$X ( k ) = {H}_{1} ( k ) + {W}_{N}^{k} {H}_{2} , k = 0 , 1 , … , N - 1$$

where H₁(k) and H₂(k) are the N/2 points DFTs of the sequences h₁(m) and h₂(m), respectively. H₁(k) and H₂(k) are periodic, with period N/2, therefore H₁(k+N/2)=H₁(k) and H₂(k+N/2)=H₂(k). In addition, the factor W_{N}^{k+N/2}=−W_{N}^{k}. Thus, the equation may be expressed as

$$X ( k ) = {H}_{1} ( k ) + {W}_{N}^{k} {H}_{2} ( k ) , k = 0 , 1 , … , \frac{N}{2}$$

$$X ( k + \frac{N}{2} ) = {H}_{1} ( k ) - {W}_{N}^{k} {H}_{2} ( k ) , k = 0 , 1 , … , \frac{N}{2}$$

where N is the number of sampling points in output discrete signal. By these equations, the FFT transform of the input signal will be calculated to present the signature of the fault in the frequency domain.

Principal Component Analysis: PCA is used for dimension-reduction. It can reduce a large set of variables to a small set that still contains the most important information in the large set, to reduce the computation time for the next stage. Feature reduction using PCA process reduces the signal dimension and extracts the important, relevant features into feature vectors. The PCA assists fault prediction at the system level in an embryonic system. The PCA is based on a mathematical procedure to transform a number of correlated variables into a (smaller) number of uncorrelated variables. The PCA depends on using an orthogonal transformation to convert variables set into values set of linearly uncorrelated variables.

PCA mathematical analysis is now presented. For a set of sample vectors x={x¹, x², x³, . . . xⁿ} and orthogonal normalized basis Aᵢ where i=1, 2, . . . , +∞. For the orthogonal basis:

$${A}_{i} {A}_{k} = \{ \begin{matrix}1 , & if i = k \\ 0 , & if i \neq k\end{matrix}$$

Each sample vector (or original vector) can be given as an infinite super position of basis vectors which a basis has the same dimension. The sample vector is expressed as:

$${x}^{n} = {\sum }_{i = 1}^{∞} {α}_{i}^{n} {A}_{i}$$

The PCA depends on representing the original sample by finite basis vector in order to reduce the error to the smallest possible. Thus, the estimated sample vector to the first d basis vector will consider the first d points and is given by:

$${\overline{x}}^{n} = {\sum }_{i = 1}^{d} {α}_{i}^{n} {A}_{i}$$

The subtraction between the above two equations is as follows:

$$\begin{matrix}x - \overline{x} = {\sum }_{i = 1}^{∞} {α}_{i} {A}_{i} - {\sum }_{i = 1}^{d} {α}_{i} {A}_{i} \\ = {\sum }_{i = 1}^{d} {α}_{i} {A}_{i} + {\sum }_{i = d + 1}^{∞} {α}_{i} {A}_{i} - {\sum }_{i = 1}^{d} {α}_{i} {A}_{i} \\ = {\sum }_{i = d + 1}^{∞} {α}_{i} {A}_{i}\end{matrix}$$

The error can be expressed using the following:

$${A}_{i}^{T} x = {\sum }_{m = 1}^{∞} {A}_{i}^{T} {α}_{m} {A}_{m} = {α}_{i}$$

$${x}^{T} {A}_{i} = {\sum }_{m = 1}^{∞} {A}_{m}^{T} {α}_{m} {A}_{i} = {α}_{j}$$

$$error = E {\sum }_{i = d + 1}^{∞} {A}_{i}^{T} {xx}^{T} {A}_{i}$$

$$error = {\sum }_{i = d + 1}^{∞} {A}_{i}^{T} E [ {xx}^{T} ] {A}_{i}$$

$$error = {\sum }_{i = d + 1}^{∞} {A}_{i}^{T} {XA}_{i}$$

Using the error value, the basis coefficients is adjusted by the error value to be as small as possible. The error is calculated using =Σ_{i=d+1}^{∞}aᵢAᵢ or =Σ_{i=d+1}^{∞}Aᵢ^{T}XAᵢ where X=E[xx^{T}]. The minimum error value is obtained under constrained condition which is Aᵢ^{T}Aᵢ=1. Therefore, the obtained equation is

XAᵢ=λᵢAᵢ

The minimum error value can be achieved when the basis vector is the eigenvectors of E(xx^{T}). These eigenvectors can be calculated using a scatter matrix S,

$$S = {\sum }_{i = 1}^{m} [ ( {x}_{i} - {X}_{j} ) {( {x}_{i} - {X}_{j} )}^{T} ]$$

The eigenvectors are used to represent the components. The first mode or component of the sample vectors is referred by the eigenvector which corresponds to the largest eigenvalue. The second component refers to the eigenvector, which corresponds to the second largest eigenvalue, and the sequence of the other components is defined in the same definition. Consequently, the sample vectors go towards a lower dimension, which presents the benefit of using the PCA technique to the next stages of learning.

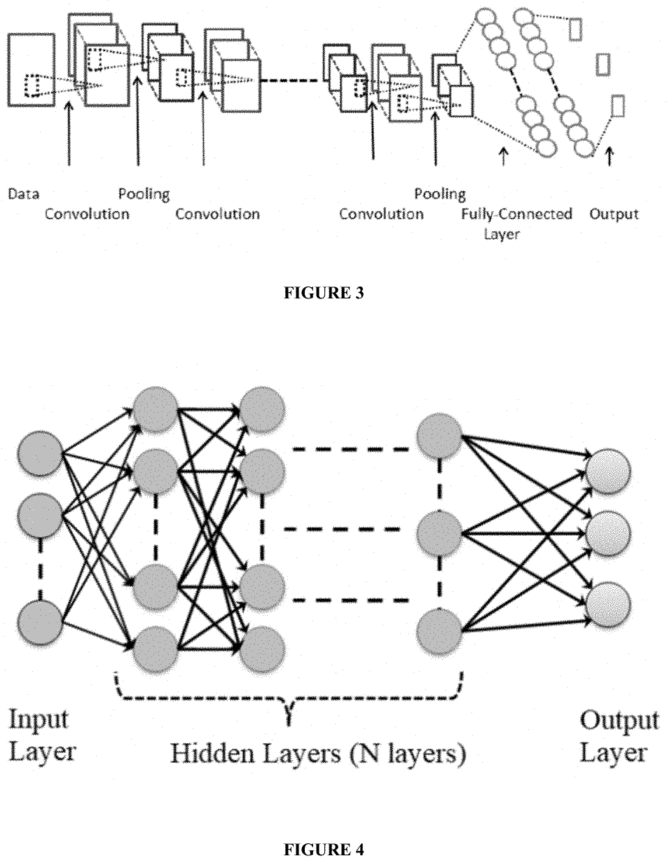

Convolutional Neural Network (CNN). CNN is used after PCA block to get PCA's output as CNN's input. The CNN architecture has three layers: convolutional, pooling, and fully connected layer, as shown in FIG. 3. The purpose of the convolutional layer is to learn feature representations of the input. It has multiple convolutional kernels to compute different feature maps. The convolution's output applies a nonlinear activation function, and the used activation function in the disclosed architecture is called Rectifier Linear Unit (RELU). The RELU function is used to add nonlinearity and provides robustness against noise in the input for the classification model, and the convolutional output size and RELU function are given in the following equations, respectively.

$$\text{?} = \frac{N - F}{S} + 1$$

$$\text{?} \text{indicates text missing or illegible when filed}$$

where F_{size} is the resulted size of convolution, N is the input size, F is the filter size, and S is the stride size.

$$f ( x ) = \{ \begin{matrix}x , & if x > 0 \\ 0 , & if x < 0\end{matrix}$$

The pooling layer comes after the convolutional layer, and its goal is to achieve shift-invariance by reducing the resolution of the feature maps to reduce the dimension of the output feature maps. The pooling layer output's size is obtained according to the filter size and moving step of the kernels (stride) as given by the above F_{size} equation. In the preferred embodiment, the pooling layer is used between two convolutional layers. Each resulting feature map is connected to its corresponding feature map of the previous convolutional layer. The average pooling type is used in this design. In our design, the number of convolutional layers and the number of pooling layers is five layers. The parameters of CNN are changed many times, and the final parameters which give the desired performance are set as follows. A filter size of 5×5 is used in the convolution operation, and the pooling layer uses a 3×3 filter size using stride, which equals one.

After multiple convolutional and pooling layers, there is a fully connected layer to perform high-level classifications. All neurons in a certain layer are connected to each neuron of the next layer to generate global semantic information as shown in FIG. 4. In the disclosed model, Softmax regression is used for classification operation. It calculates the probabilities of each class versus all other classes, and the function is obtained by, the following equation, where x is the input signal and K is the number of output classes:

$$f ( {x}_{j} ) = \text{?} for j = 1 , 2 , 3 , … , k$$

$$\text{?} \text{indicates text missing or illegible when filed}$$

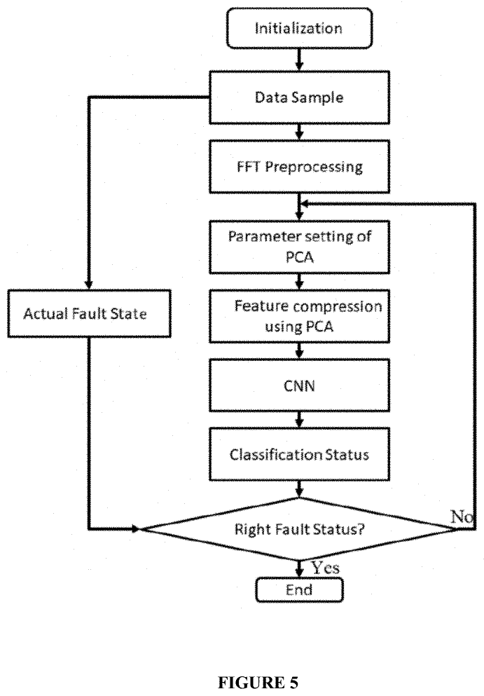

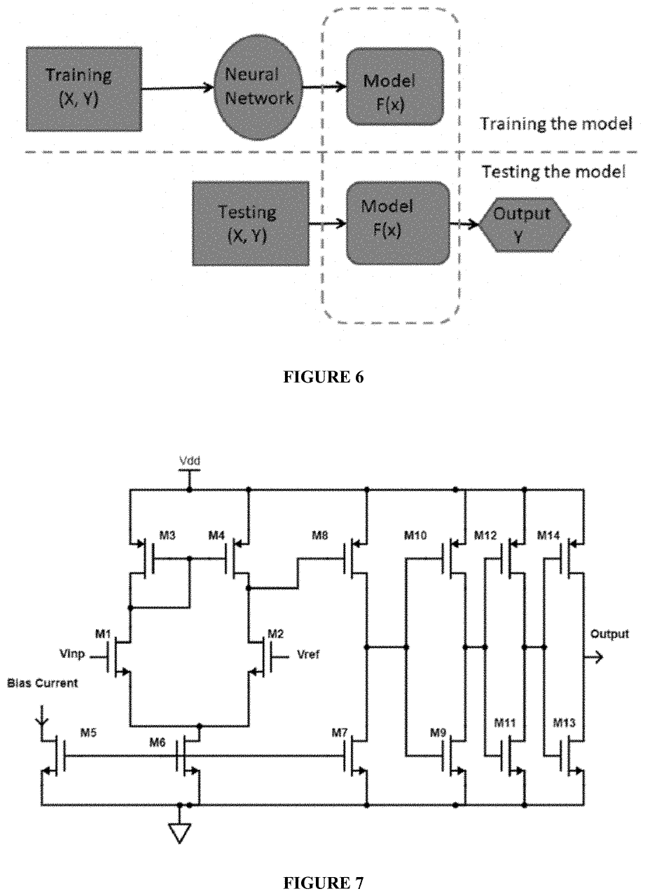

Training and Testing. The training steps of the disclosed method are shown in FIG. 5. The total number of samples is 14683 samples are used for training, validation, and testing. In the training mode, the 60% of the samples are used to training, and they are 8809 samples. The 20% of the samples (2937 samples) are used for validation, and 20% (2937 samples) are used for testing. The data sample applies to the FFT preprocessing to get the data signature in the frequency domain. The output result of FFT is transferred to parameters setting of PCA to get feature compression by using a vector basis. The feature selection and compression extraction in this step gets the uncorrelated data with small dimensions. The CNN stage gets the PCA stage's output as its input to complete feature extraction and the learning steps. The next stage is the classification stage is used to determine the fault status. Finally, the predicted fault status is compared with the actual fault status. If the predicted fault is the same as the actual fault, the training will stop. Otherwise, feedback of the result returns to the parameter setting of PCA to update coefficients for getting more accurate learning. This iteration continues until the predicted fault status is the same as the actual one. In the testing phase, new data is applied to FFT transformation, the FFT's result is sent to the PCA processing. The roles of CNN and classification comes after PCA processing to complete the process, and they provide the final classification decision of the fault. The structure of the flow is shown in FIG. 5. The model of training and testing is shown in FIG. 6.

The process is divided into phases: training and testing. In the training phase, an Input x is applied to training the neural network to build up a model F(x) for the input data, and this model is used for testing future inputs. In the testing phase, the model is tested with new input x to verify its operation, and the model provides the corresponding output of Y=F(x) for the input x. Output data of the PCA block is applied to the neural network for training. In a training case, the neural network will learn to build a pattern of the fault shape and this training will be presented in a model. A model includes a hypothesis of the output depending on the applied data. Thus, this model is used to classify the output during a testing stage. The testing is the next step after training to test the new inputs. In the testing case, the inputs are applied to FFT and PCA process, and then the result is used for testing the network. The PCA data is applied to the learning network using the model, which is built during a training stage to get the classification.

Evaluation of the disclosed method is then discussed, which was studied on Tensorflow and Altera Arria 10 GX FPGA 10AX115N2F45E1SG device. Metrics of evaluation is described as follows.

True-Positives (TP): True-positive refers to the total number of prediction failures correctly within a specific duration. For example, if the corrected number of predictions is 85 from 100 within 1 minute, then the true-positive will be 85.

False-Positives (FP): False-positive is the number of failures which have not occurred but mistakenly predicted within a specific duration.

False-Negatives (FN): False-negative is the total number of unpredictable failures which has been occurred within a specific duration. For example, the corrected number of predictions is 85 from 100 within 1 minute, it means the number of unpredictable failures is 15. Thus, the false-negative equals 15.

Sensitivity: Sensitivity refers to the ratio between the corrected number of identified failures and the total sum of true-positive and false-negative. Sensitivity can be expressed by:

$$Sensitivity = \frac{TP}{TP + FN}$$

Precision: Precision is the ratio between the corrected number of identified failures and the sum of the corrected and uncorrected predicted failures. Thus, precision can be expressed in terms of true-positives and false-positives as:

$$Precision = \frac{TP}{TP + FP}$$

Tension: It is the relation between sensitivity and precision, which should be balanced. Increasing precision results in a decreasing sensitivity, so, there is a trade-off between them. The sensitivity improves with low false-negatives which results in increasing false-positives, and it reduces the precision. For example, in preliminary fault screening of a hardware system for follow-up maintenance, it would probably need a sensitivity near to “1” to find the hardware section which has the fault, and we can accept a low precision if the follow-up maintenance is not significant. The tension is given by:

$$Tension = \frac{2 * Sensitivity * Precision}{Sensitivity + Precision}$$

Specificity: It measures the proportion of actual negatives that are correctly identified.

$$Specificity = \frac{TN}{TN + FP}$$

Accuracy: The accuracy of a test is its ability to differentiate classes correctly.

$$Accuracy = \frac{TP + TN}{TP + TN + FP + FN}$$

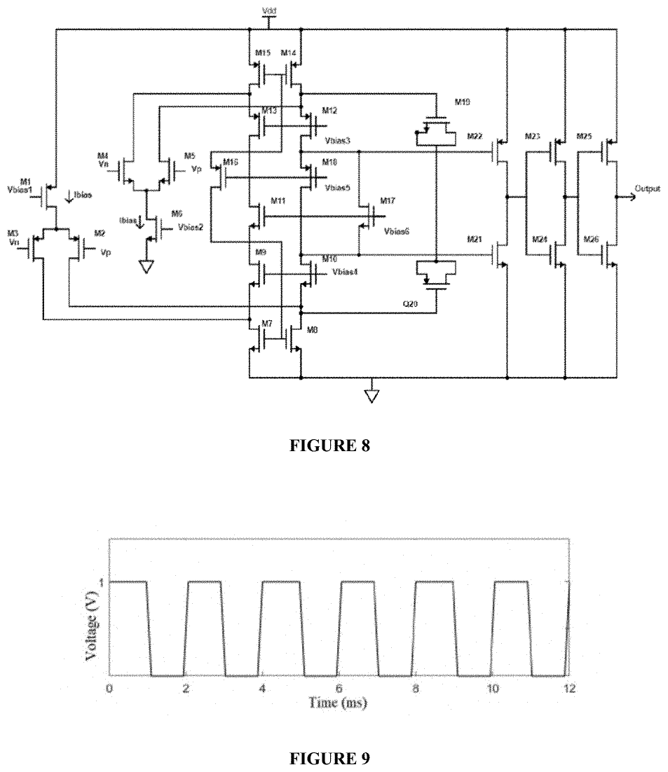

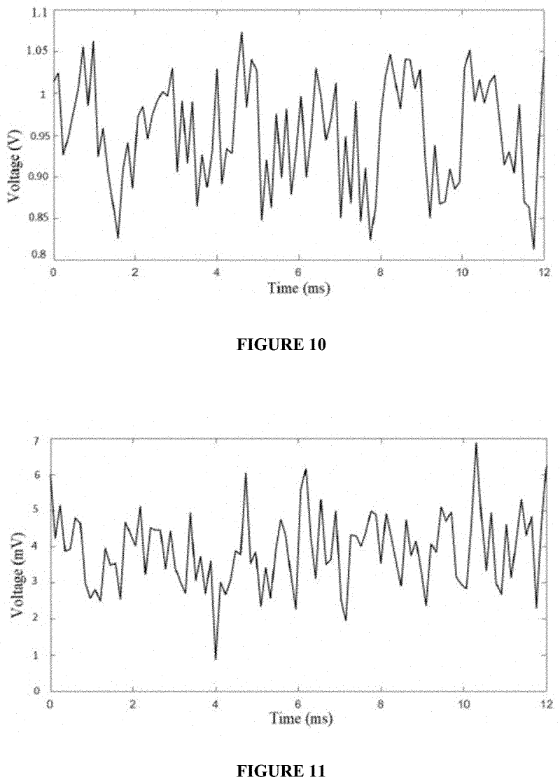

The disclosed approach is implanted to predict faults in the comparator and amplifier circuits. The comparator schematic diagram is shown in FIG. 7, and the schematic diagram of the amplifier is shown FIG. 8. Two basic current sources are used for the operational amplifier. The comparator and amplifier comprise a number of transistors and we focus on transistor fault prediction. The comparator and amplifier circuits are implemented on HSPICE using 45 nm technology with voltage source of 1 V to simulate it in normal mode and faulty mode. The AC analysis for the comparator and amplifier is described as follows. For the comparator the input signal is a square wave as shown in FIG. 9. The reference voltage is used to be 0.5 V, so, if the input is higher than 0.5 V, the output is high. The output is low if the input value is lower than 0.5 V. The resistance load of this circuit is 1 K and a temperature of 300 K. The output signal is the same as the input signal in the normal case. The resulted output for open-circuit and short-circuit faults are shown in FIG. 10 and FIG. 11, respectively.

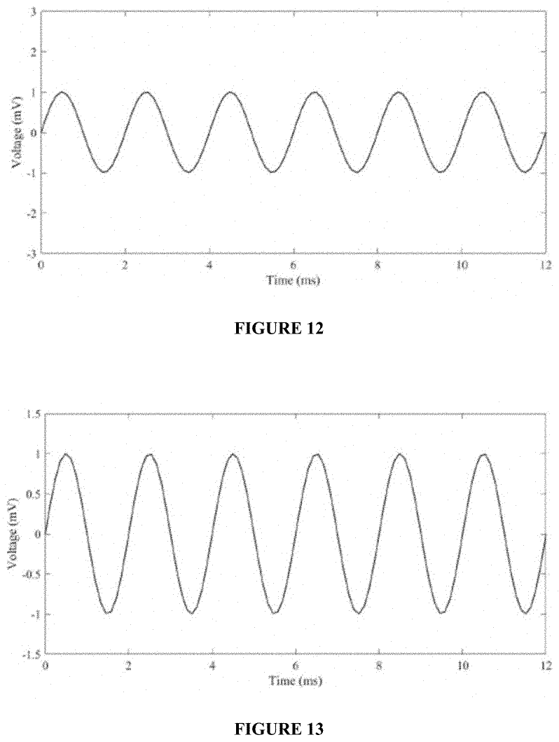

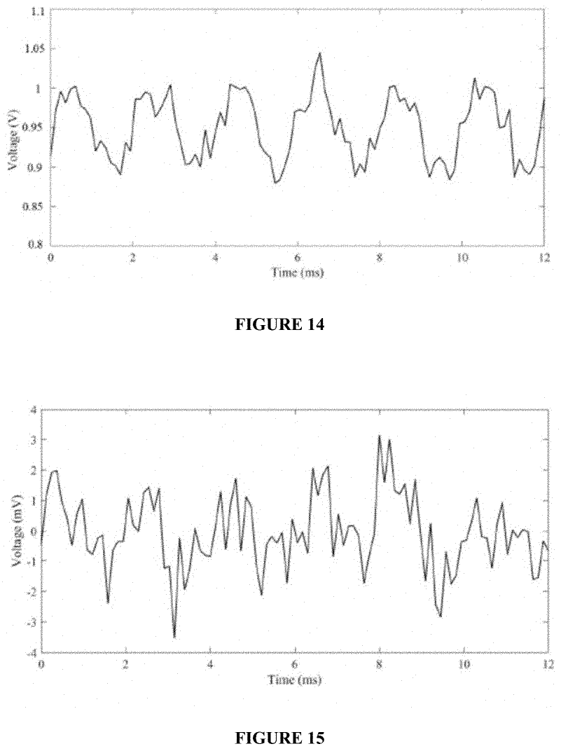

For the amplifier circuit, a sine wave is used as input as shown in FIG. 12. The load resistance and temperature are 1 K and 300 K, respectively. The output in the normal state is amplified signal as shown in FIG. 13. The output is distorted due to open-circuit and short-circuit faults as shown in FIG. 14 and FIG. 15, respectively. These results indicate the effect of faults on the performance of the circuits. Fault prediction parameters (voltage, current, temperature, delay, noise, EM, etc.) are modified in the simulation, and we extracted the behavior of the transistor to consider aging, short-circuit, and open-circuit faults. We have tried the simulation 100 times to get a more accurate dataset. This dataset is used for learning the disclosed approach. In practice, analog signals are read, and this can be periodical. These values are used in FFT operation for the frequency domain purpose. The result is performed by PCA to select the essential data to apply it for CNN learning and classification. This is beneficial in several applications such as biomedical machines, aerospace devices, military machines, etc.

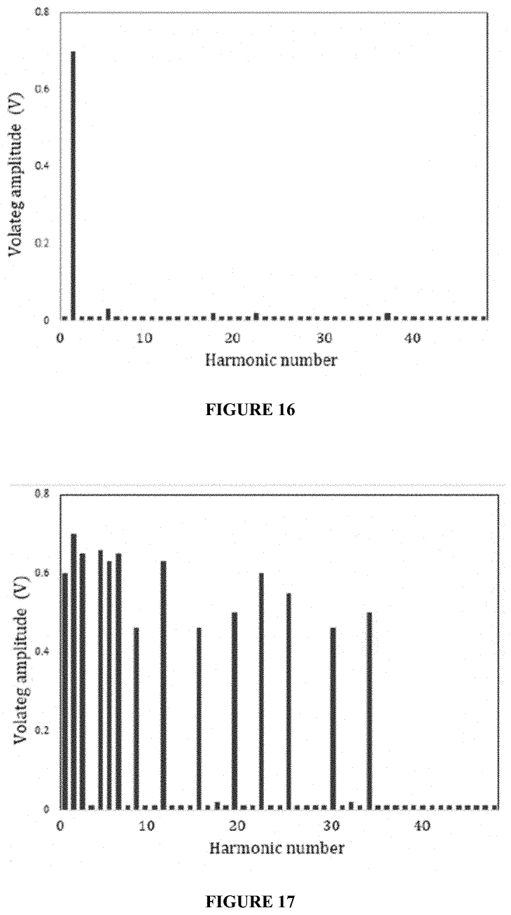

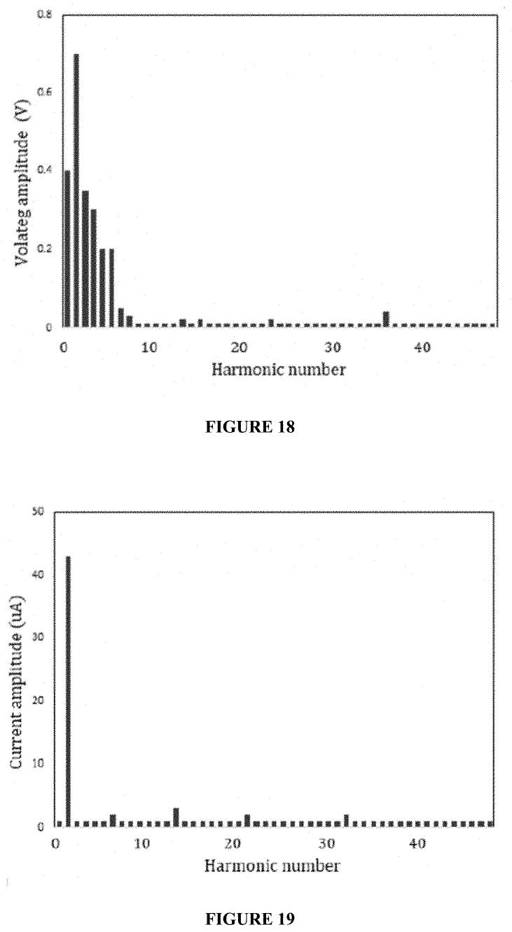

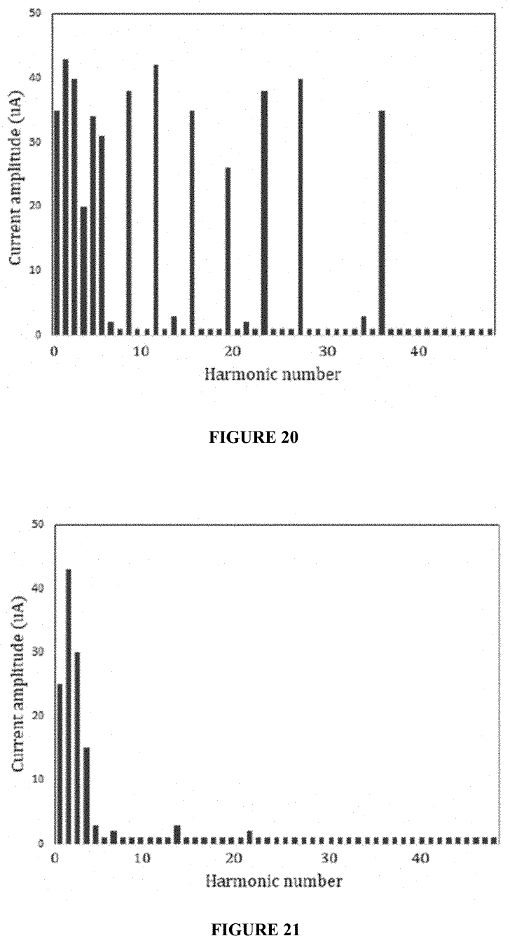

The disclosed method is implemented on Tensorflow to show the prediction learning performance. The extracted data is applied to the FFT transformation stage to present data in the frequency domain. In this stage, a sampling frequency f of 60 kHz is used with a measuring time of 0.3 s in each simulation, so the sampling number N is 1800. The sampled output signals are converted by FFT into 0-49 harmonics. The first value which 0 represents the DC component of the output signals. The disclosed method is tested 100 times, and the first 42 harmonics are found to be sufficient to meet the demand for the accuracy of fault diagnosis. For voltage parameter, the FFT of the voltage signal in normal mode without any fault is shown in FIG. 16. In case faulty mode, the FFT of the voltage signal in open-circuit and short-circuit faults, respectively, are presented in FIG. 17 and FIG. 18. For another parameter, the FFT of the current signal in normal mode, open-circuit fault, and short-circuit fault are shown in FIG. 19, FIG. 20, and FIG. 21, respectively. The same procedures are done on the rest of the parameters.

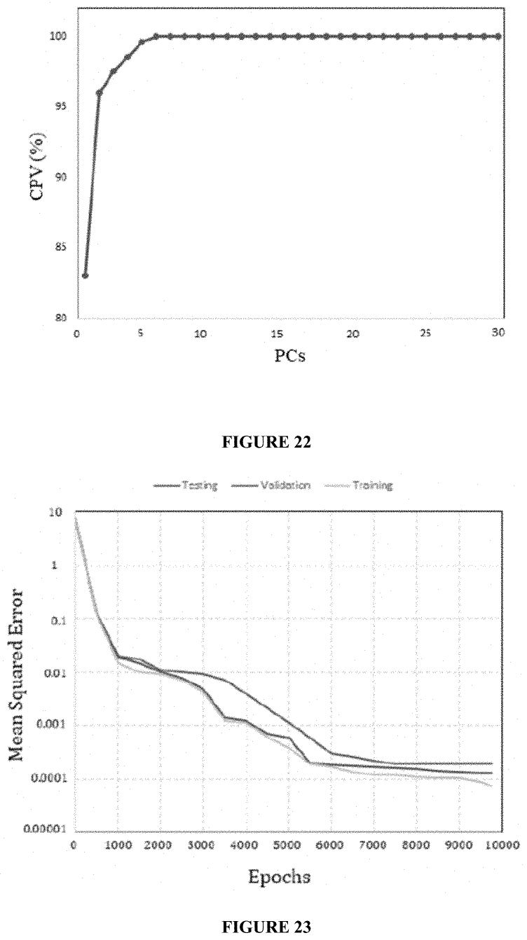

The FFT indicates a difference in the frequency domain of a parameter signal in normal and faulty mode. Therefore, the benefit of FFT is to get a unique signature of each fault, which helps in the learning. The next step after FFT is PCA, in this stage, the role of PCA is to get the most important parameters by transforming the correlated data to uncorrelated data. The vector basis is used in this transformation. A Cumulative Percentage of Variance (CPV) is used to measure the principal components using variation value selected by the first n latent variables. The results show the first Principal Component (PC) of PCA contains 84% of the total energy as shown in FIG. 22. The first and second PCs contain 96% of the total energy, and the result will be constant after the 5th PC. Therefore, we can use the first or second component for data presentation.

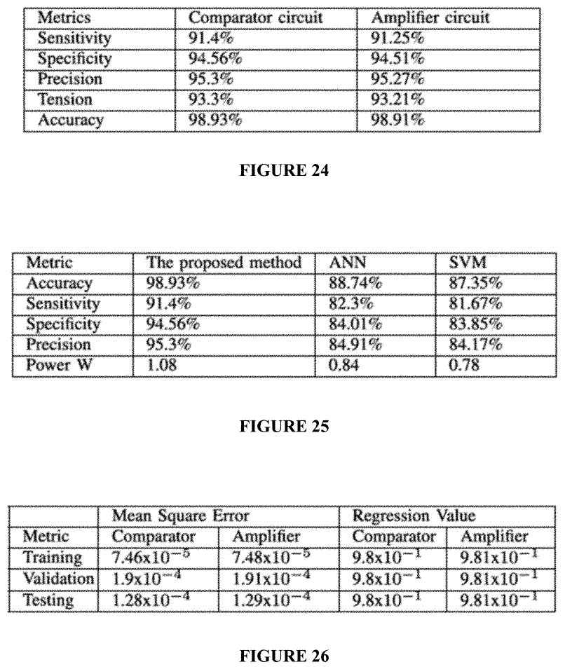

The CNN role comes after PCA for learning. The CNN is implemented by five convolutional layers with filter size 5×5, five convolutional layers, and five pooling layers with filter size using one step stride. The last stage is the classification stage, which is based on the fully-connected layer, and it classifies the fault at the final output. The fully-connected layer is implemented by three hidden layers, and each layer has 1,000 neurons, and the last output layer has three neurons. The simulation results of the total behavior in terms of accuracy, specificity, etcare shown in FIG. 24. The result shows the disclosed approach can predict a fault with high-accuracy. A comparison between the disclosed method and the state-of-the-art techniques for the comparator circuit is shown in FIG. 25. The method of using FFT and CNN gives an accuracy of 97.16%, while the disclosed method has higher accuracy. The disclosed method has the capability to greatly improve diagnostic accuracy, and reduce the running time. Therefore, the disclosed method is competitive with techniques known in the art. We studied the mean square error, which is the average squared difference between the final output of CNN and the target value, and the simulation result is shown in FIG. 23. Furthermore, the regression value is studied which, refers to the correlation between the final output and the actual target value. The result of both mean square error and regression are shown in FIG. 26. The digital signal processing utilizes Fourier transform, which can be used in the fault prediction process. Therefore, this FFT is not an additional step. On the one hand, the fault prediction using FFT and CNN, provides an accuracy of 98.97% while the training time is 11.9 minutes, and the number of training parameters is 510,317. On the other hand, the disclosed method using “FFT+PCA+CNN” provides an accuracy of 98.93% with a training time of 3.2 minutes, and the number of parameters is 25,385. These results show the disclosed method provides almost the same accuracy while the number of parameters and the training time are less. The fault prediction method is used as a pre-stage of a self-healing method. The idea is based on recovering future faults. Therefore, the need for fault prediction within minimum time is significant to allow the self-healing method recovers the fault early. If the fault prediction technique spends a longer time, this may affect the time before healing to be shorter. Therefore, we focused to provide a fault prediction method with high speed. Thus, the disclosed method is efficient, suitable, and reliable for real-time applications.

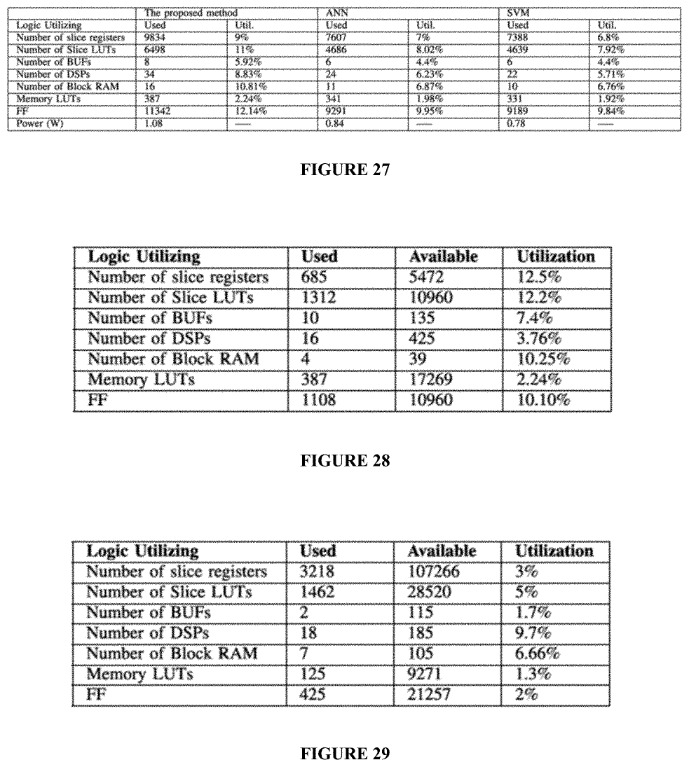

The disclosed approach has been implemented on hardware using VHDL and Xilinx Vivado on Altera Arria 10 GX FPGA 10AX115N2F45E1SG device. The simulation results of the hardware implementation in terms of registers, LUTs, DSPs, Buffers, block RAM, Flip Flop (FF), and power are shown in FIG. 27 for the disclosed method, ANN, and SVM. These are the consumed hardware resources for the disclosed, ANN, and SVM methods. The hardware resources consumption for FFT and PCA are shown in FIG. 28 and FIG. 29, respectively. These results present the used resources, which are the consumed resources, and utilization (Util.) which is the ratio of used resources to the total available resources. The disclosed method has a delay of 350 ms. The power consumption of the disclosed method is 1.08 W, which is comparable with the ANN, SVM methods 0.84 W and 0.78 W, respectively. The operating frequency is 120 MHZ. The disclosed approach will be very beneficial for fault tolerance where the fault prediction allows fault tolerance or self-healing method to fix this fault early without affecting the system performance. It is desirable to apply a self-healing in aerospace hardware devices. The cost of fixing faults using external interference is high.

The result shows the disclosed approach has high-accuracy to predict fault, which can be used to fix this fault by self-healing or isolating the defective components and keeping the system works using the available components. The disclosed method in a system, a self-healing method is not triggered until getting a signal indicative of a fault. If the system has a future fault, the disclosed method predicts a fault within 27 clock cycles, and it provides the type of fault and coordinates to the self-healing method. Once the self-healing method gets this information, it performs a self-healing mechanism to recover this fault. Based on our experimental observations, the disclosed method of transistor-level fault prediction can be applied to more complex circuits accurately. The cost of repair may vary depending on a unit that may need replacement. For very complex systems, however, system-level fault detection and healing may be more economical. Continued research in this area will shed more light on the usage, accuracy, and tradeoff of fault prediction and healing at different levels of design abstractions. The disclosed method utilizes the existing FFT of a system, if present, to avoid adding an additional FFT block. To save power consumption, the disclosed method can be applied periodically instead of running all the time. This period can be selected to be less than or equal to the prediction time of the disclosed method to not lose the prediction.

This paper presented an approach of early transistor fault prediction using FFT, PCA, and CNN. The disclosed approach utilizes the fault signature in the frequency domain by FFT. The FFT result is applied to PCA to get the most important values with less dimension. The CNN stage is used subsequently to complete the final feature presentation and fault classification. The disclosed approach is tested on the comparator and amplifier circuits which are implemented using 45 nm technology to study the transistor fault in terms of aging, short-circuit, and open-circuit faults. The disclosed approach is implemented using Tensorflow, and the result shows the disclosed approach could predict a fault by the accuracy of 98.93%. The disclosed method contributes to providing a high accuracy to a diagnostic fault within reasonable time. The disclosed method is compared with the state-of-the-art methods, and the result shows the disclosed method has a more accurate result with a lower error. Finally, the disclosed approach is implemented in hardware VHDL on Altera Arria 10 GX FPGA 10AX115N2F45E1SG device, and it consumes 1.08 W.

Although the description herein uses terms first, second, etc., to describe various elements, these elements should not be limited by the terms. These terms are only used to distinguish one element from another.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims.

This application discloses several numerical ranges in the text and figures. The numerical ranges disclosed inherently support any range or value within the disclosed numerical ranges, including the endpoints, even though a precise range limitation is not stated verbatim in the specification, because this disclosure can be practiced throughout the disclosed numerical ranges.

The above description is presented to enable a person skilled in the art to make and use the disclosure, and it is provided in the context of a particular application and its requirements. Various modifications to the preferred embodiments will be readily apparent to those skilled in the art, and the generic principles defined herein may be applied to other embodiments and applications without departing from the spirit and scope of the disclosure. Thus, this disclosure is not intended to be limited to the embodiments shown but is to be accorded the widest scope consistent with the principles and features disclosed herein. Finally, the entire disclosure of the patents and publications referred in this application are hereby incorporated herein by reference.

We claim:

1. A method for predicting faults in electronic computing hardware system comprising:
(a) identifying the input data of the hardware system;
(b) obtaining a frequency transformation of the input data by applying Fast Fourier Transformation (FFT);
(c) filtering out unnecessary data by performing Principal Component Analysis (PCA);
(d) inputting the PCA output information into the Convolutional Neural Network (CNN);
(e) performing feature extracting and learning;
(f) performing high level classification to find an actual fault status;
(g) training the CNN, comprising comparing a predicted fault status to the actual fault status, wherein
i. if the predicted fault status does not match the actual fault status, the actual fault status is reported to the PCA; and
ii. repeating steps (c)-(g) until the predicted fault status matches the actual fault status, wherein then training of the CNN ceases;
(h) testing prediction accuracy by repeating steps (a) through (g) utilizing new input data.

2. The method of claim 1, wherein the FFT step further comprises preprocessing the input data to perform data compression and feature extraction.

3. The method of claim 1, wherein the FFT step comprises:
(a) assuming x_{i,n} is a discrete output signal (e.g., voltage, current, temperature, . . . ) with i=1, 2, 3, . . . m and n=0, 1, 2, 3, . . . , b−1 where b is a retained harmonics size and m is a training samples size;
(b) performing the following calculations:
$$X ( k ) = {\sum }_{n = 0}^{N - 1} x ( n ) {W}_{N}^{kn} , k = 0 , 1 , … , N - 1 \\ {W}_{N} = {e}^{\frac{- j 2 π}{N}} \\ X ( k ) = {\sum }_{n even} x ( n ) {W}_{N}^{kn} + {\sum }_{n odd} x ( n ) {W}_{N}^{kn} \\ X ( k ) = {\sum }_{m = 0}^{\frac{N}{2} - 1} x ( 2 m ) {W}_{N}^{2 k m} + {\sum }_{m = 0}^{\frac{N}{2} - 1} x ( 2 m ) {W}_{N}^{2 k m}$$
(c) defining W_{N}²=W_{N/s} such that an equation for FFT can be represented as
$$\begin{matrix}= {\sum }_{m = 0}^{\frac{N}{2} - 1} {h}_{1} ( m ) {W}_{N / 2}^{k m} + {\sum }_{m = 0}^{\frac{N}{2} - 1} {h}_{2} ( m ) {W}_{N / 2}^{k m} \\ X ( k ) = {H}_{1} ( k ) + {W}_{N}^{k} {H}_{2} ( k ) , k = 0 , 1 , … , N - 1\end{matrix}$$
wherein H₁(k) and H₂(k) represent an N/2 points Discrete Fourier Transform of sequences h₁(m) and h₂(m), respectively;
wherein H₁(k) and H₂(k) are periodic, with period N/2, such that H₁(k+N/2)=H₁(k) and H₂(k+N/2)=H₂(k);
(d) defining a factor W_{N}^{k+N/2}=−W_{N}^{k} such that an equation for FFT can be expressed as:
$$X ( k ) = {H}_{1} ( k ) + {W}_{N}^{k} {H}_{2} ( k ) , k = 0 , 1 , … , \frac{N}{2} \\ X ( k + \frac{N}{2} ) = {H}_{1} ( k ) - {W}_{N}^{k} {H}_{2} ( k ) , k = 0 , 1 , … , \frac{N}{2}$$
wherein N is a number of sampling points in an output discrete signal;
(e) applying the equations to transform a signal of the input data;
(f) presenting a signature of a fault in the input data in a frequency domain.

4. The method of claim 1, wherein the PCA step transforms a number of correlated variables into a smaller set of uncorrelated variables through orthogonal transformation.

5. The method of claim 1, wherein the PCA step comprises:
(a) establishing a set of sample vectors x={x¹, x², x³, . . . xⁿ} and an orthogonal normalized basis Aᵢ where i=1, 2, . . . , +□;
(b) establishing that for the orthogonal normalized basis:
$${A}_{i} {A}_{k} = \{ \begin{matrix}1 , & if i = k \\ 0 , & if i \neq k\end{matrix}$$
(c) establishing an original vector wherein each vector comprises an infinite super position of basis vectors which a basis has a same dimension;
(d) expressing the original vector through Equation 1, comprising:
$${x}_{n} = {\sum }_{i = 0}^{∞} {α}_{i}^{n} {A}_{i}$$
(e) minimizing error size by representing the original vector by finite basis vector;
(f) considering initial d points by an estimated original vector to a first d basis vector, represented by Equation 2, comprising:
$${\tilde{x}}^{n} = {\sum }_{i = 1}^{d} {α}_{i}^{n} {A}_{i}$$
(g) subtraction Equation 1 from Equation 2, comprising:
$$\begin{matrix}x - \tilde{x} = {\sum }_{i = 1}^{∞} {α}_{i} {A}_{i} - {\sum }_{i = 1}^{d} {α}_{i} {A}_{i} \\ = {\sum }_{i = 1}^{d} {α}_{i} {A}_{i} + {\sum }_{i = d + 1}^{∞} {α}_{i} {A}_{i} - {\sum }_{i = 1}^{d} {α}_{i} {A}_{i} \\ = {\sum }_{i = d + 1}^{∞} {α}_{i} {A}_{i}\end{matrix}$$
(h) calculating an error value using the following expressions;
(i) adjusting one or more base coefficients by the error value to be as small as possible;
(j) calculating the minimum error value under a constrained condition comprising Aᵢ^{T} Aᵢ=1;
(k) achieving the minimum error value when the basis vector is one or more eigenvectors of E(xx^{T}); and
(l) calculating the one or more eigenvectors by using a scatter matrix;
wherein the one or more eigenvectors represent one or more components of the original vector, such that each component of the original vector is referred to by an eigenvector that corresponds to an eigenvalue comparable in size to the subject original vector.

6. The method of claim 5, wherein the error value is calculated through the following expressions:
$${A}_{i}^{T} x = {\sum }_{m = 1}^{∞} {A}_{i}^{T} {α}_{m} {A}_{m} = {α}_{i} \\ {x}^{T} {A}_{i} = {\sum }_{m = 1}^{∞} {A}_{m}^{T} {α}_{m} {A}_{i} = {α}_{i} \\ error = E {\sum }_{i = d + 1}^{∞} {A}_{i}^{T} x {x}^{T} {A}_{i} \\ error = {\sum }_{i = d + 1}^{∞} {A}_{i}^{T} E [ x {x}^{T} ] {A}_{i} \\ error = {\sum }_{i = d + 1}^{∞} {A}_{i}^{T} X {A}_{i}$$

7. The method of claim 1, wherein the CNN comprises at least a convolutional layer, a pooling layer, and a fully connected layer.

8. The method of claim 1, wherein the CNN comprises three convolutional layers, two pooling layers, and a fully connected layer;
wherein each pooling layer is used between two convolutional layers.

9. The method of claim 7, wherein the convolutional layer's comprises functionality to learn feature representations of the input data.

10. The method of claim 7, wherein the convolutional layer comprises two or more computational kernels capable of computing feature maps.

11. The method of claim 7, wherein the convolutional layer's output applies a nonlinear activation function comprising a Rectifier Linear Unit (RELU).

12. The method of claim 11, wherein the convolutional output size can be determined through the following:
$${F}_{size} = \frac{N - F}{S} + 1$$
wherein F_{size} is the convolutional output size, N is an input size, F is a filter size, and S is a stride size; and
the RELU function may be represented as:
$$f ( x ) = \{ \begin{matrix}x , & if x > 0 \\ 0 , & if x < 0\end{matrix} .$$

13. The method of claim 1, wherein the CNN comprises three convolutional layers, two pooling layers, and a fully connected layer;
wherein each pooling layer is used between two convolutional layers; and
wherein the pooling layer comprises functionality to achieve shift invariance by reducing a resolution of one or more feature maps to reduce a dimension of one or more output feature maps.

14. The method of claim 7, comprising obtaining the pooling layer's output size according to filter size and stride.

15. The method of claim 13, wherein each output feature map is connected to its corresponding feature map in the prior convolutional layer.

16. The method of claim 7, wherein the fully connected layer performs the high level classification through Softmax regression.

17. The method of claim 5, wherein the actual fault status is reported to the PCA to update the coefficients to increase accuracy of fault predictions.
